(19) United States
(12) Patent Application Publication
(10) Pub. No.: US 2005/0072237 A1
(43) Pub. Date: Apr. 7, 2005

(54) Pipeline inspection pigs

(76) Inventors: David Paige, Newcastle-upon-Tyne (GB); Andrew Mann, Northumberland (GB); Ian Smith, Northumberland (GB)

Correspondence Address: STITES & HARBISON PLLC, 1199 NORTH FAIRFAX STREET, SUITE 900, ALEXANDRIA, VA, 22314, US

(21) Appl. No.: 10/488,555

(22) PCT Filed: Sep. 3, 2002
(86) PCT No.: PCT/GB02/04031

(30) Foreign Application Priority Data
Sep. 5, 2001 (GB) 0121470.9

(51) Int. Cl. G01N 29/10

(52) U.S. Cl. 73/623

(57) ABSTRACT

A pipeline inspection pig for locating crack-like defects (10) in pipeline walls (8) comprises at least one transmit transducer (T) for transmitting ultrasound energy into the pipeline wall (8), and at least one associated receive transducer (R) located adjacent the transmit transducer (T), the arrangement being such that, for a given defect (10) in the pipeline wall (8), ultrasound energy within the pipeline wall (8) is incident on the defect (10), part of said energy being reflected by the defect (10) back to the receive transducer (8) in the form of a first data stream, and the remainder of said energy passing through the defect (10) to be attenuated thereby and thence returned to the receive transducer (R) in the form of a second data stream, interpretation of the first and second data streams enabling the location of the defect (10) to be determined.

### TECHNICAL FIELD

This invention relates to pipeline inspection pigs, and more specifically to such pigs in which the structural integrity of pipelines is detected using ultrasonic transducers, more particularly but not exclusively electromagnetic acoustic transducers hereinafter referred to as EMAT transducers, mounted on the pigs.

### BACKGROUND ART

The structural integrity of pipelines is conventionally determined using inspection pigs which travel inside the pipeline and measure the condition of the pipe walls, the remaining strength of the pipeline being calculated from a knowledge of the significance of metal loss, cracking or other defects found by the inspection pig.

There are many technologies and physics principles which have been proposed or used for detecting and measuring the size of the defects, but magnetic flux leakage and ultrasonic testing have evolved as the most useful technologies in practice. Although there is considerable overlap in their areas of application, magnetic flux leakage is of most use in measuring significant metal loss (corrosion or gouging) from the walls of both gas and liquid product pipelines. In contrast, ultrasonics has its main application in measuring cracks in the pipe wall material, but is commonly limited to liquid product pipelines, because, for conventional ultrasound transducers, liquid is needed to conduct the ultrasound into the pipe walls. However, many gas product pipelines have cracks therein, so there is considerable development activity to extend ultrasonics to the inspection of these pipelines.

EMAT technology is one way of directly exciting ultrasound in the walls of the pipes and does not require a liquid to convey the sound from the transducer into the walls of the pipes. EMAT technology has been proposed on a number of occasions, and has been used on an experimental basis, for inspection pigs intended to find crack-like defects in pipelines. So far, however, no pipeline inspection company has a practical working system in commercial use anywhere in the world.

The main advantages of EMAT technology are in providing ultrasonic inspection without the requirement for liquid or physical coupling in gas pipes, and the ability to excite several specific wave modes which are beneficial for inspection and which cannot be excited by conventional piezoelectric transducers.

Disadvantages includes Barkhausen noise in ferromagnetic pipes, high electrical power requirements and physically large transducers compared to piezoelectric variants of similar inspection performance. A further disadvantage is encountered when operating transducers designed to transmit ultrasound in a direction parallel to the surface of a plate or pipe-wall. These have relatively low operating frequencies, and hence produce broad divergent beams of ultrasound, so reducing the resolving power of the system and hence the ability to size and discriminate defects.

For flux leakage inspection, the transducers measure directly the flux distortion caused by the shape of the missing metal. Such transducers provide greatest sensitivity to the flux if they are as close as possible to the region of the missing metal. Good inspection, therefore, requires a uniform high-density array of transducers, which makes measurements at closely spaced intervals around the circumference of the pipe, and which ensures that any defect passing the array is detected by at least one transducer passing physically close to the defect.

In contrast, for ultrasonic inspection of cracks, a transmit transducer injects a pulse of ultrasound at a point in space and time, and the energy of this pulse spreads out in a wave motion analogous to ripples from a stone dropped in water. The wave motion is disturbed by any crack-like defects in the pipe wall which cause some reflection of the incident wave and some attenuation of the wave as it continues in the original direction. These reflected and attenuated waves can be measured by associated receive transducers, which may be the same as, or positioned very close to, the transmit transducers. Alternatively, the receive transducers may be at a considerable distance from the transmit transducers, in which case the defect can be distant from both the transmit and the receive transducers, and at an arbitrary position between them. The latter arrangement allows pipe inspection to be achieved using a relatively low density of transducers compared to magnetic flux leakage inspection, since the transducers need not be physically close to each defect.

The action of injecting an ultrasound pulse, particularly using EMAT technology, produces a large electro-magnetic and acoustic disturbance that masks any reflection directly adjacent to the transducer. Inspection, therefore, is of a part of the pipe wall distant from the transducers, but not so distant that the ultrasosund has decayed to an ineffective level. In the case of EMAT transducers, designed to send acoustic signals predominantly parallel to the pipe wall, for example to propagate around the circumference of the pipe, there is a short distance along the surface of the pipe adjacent to a transducer for which inspection is not possible. Increasing the circumferential density of the transducers does not yield an automatic improvement in inspection quality. Instead, a low density array of carefully spaced sensors yields a more effective inspection system. This is quite different from the case of magnetic flux leakage systems where the quality of inspection can always be improved by increasing the density of the sensor array and its closeness to the pipe wall surface. A typical ultrasonic crack measurement pig, particularly employing EMAT technology and propagating waves around the circumference of the pipe, will have a relatively small number of sensors each inspecting a proportionately larger section of the pipe wall.

When operating several ultrasonic transducers by sending ultrasonic pulses from a low density array, care must obviously be taken to ensure that the ultrasonic signals received by the transducers can be used to reconstruct in a unique manner the location and nature of any defects in the pipe. Particular care has to be taken, because there can co-exist within the pipe wall many different ultrasonic pulses circulating from different transducers and in different states of reflection or attenuation. These pulses usually continue to propagate for some time after they have caused the echo signals or attenuation signals that yield the important measurements of a defect. These lingering pulses soon become spurious pulses of uncertain origin and information content, and will produce spurious detections many times by many transducers as they decay.

It is also helpful when operating a low density array of ultrasonic transducers that the number of receive transducers is relatively low and that they detect meaningful information over a relatively long time interval within each listening cycle for the transducer. The alternative of having large numbers of receive transducers and short useful time windows is more expensive to implement, and places greater demands on the receiving electronics, which must then have either greater duplication of ‘front end’ components or more complicated multiplexing capabilities.

The best possible quality of inspection in this situation is achieved by collecting as much useful information as possible about the interaction between the ultrasound and the defect subject to practical restraints on transducer numbers. In practice this means balancing at least three conflicting requirements. The first is that it is desirable to employ the maximum possible pulse rate to give a large number of data points for each defect as the pig moves forward. The second is that as many pulses as possible that are detected by the receive transducers have unambiguous trajectories within the pipe wall and that measurements of the pulse amplitudes and times are therefore diagnostic of the defect geometry and location. The third is that this is achieved with a relatively economic arrangement of transducers, particularly those employed to receive ultrasound if different from those that transmit the ultrasound.

The present invention has been devised with a view to improving the quality of the inspection provided by ultrasonic transducers propagating waves around the pipe circumference, including EMAT transducers of this type, within the context of an inspection pig working in a transmission pipeline.

When EMAT transducers, or indeed any type of ultrasonic transducer, is used to measure crack-like defects in a metal plate structure such as a pipeline, there are two common modes of use. In the first, an EMAT transmitter initiates a beam of ultrasound energy which travels through the metal structure until it reaches the crack-like defect or other feature where at least some of the energy is reflected by the defect and at least some of this reflection travels back along the initial path to an EMAT receiver located in the vicinity of the transmitter. It is in fact possible for the transmitter and receiver to be the same unit. The signals produced by the receive transducer are measures of the quantity and quality of the reflection from the crack-like defect or other feature.

In the second mode of use, an EMAT transmitter initiates a beam of ultrasound as before, but the receive transducer is located some distance from the transmitter along the direction of the beam. In this case, the signals produced by the receive transducer are measures of the reduction in the ultrasound as a result of passing the crack-like defect or other feature.

Each mode of use provides distinct and different information about the crack-like defect or other feature.

The other major factor influencing inspection quality is the repetition rate for injecting the ultrasound pulses for each defect location. During the inspection of the pipeline, the inspection pig is continuously moving forward, so each successive pulse gives information about a defect from an axially displaced viewpoint. The more pulses there are, the more data there is about how the defect changes along the pipe. A major factor determining the maximum repetition rate is the time taken for the ultrasound from one pulse to decay to such a low level that it will not mask the information generated by the next pulse. As an example, using typical numbers for one particular case, consider inspection of a 900 mm diameter steel pipe using shear waves propagating around the circumference. The speed of ultrasound in this pipe will be approximately 3 mm/μsec, and the circumference of the pipe is approximately 3000 mm. It will therefore take about 1 millisecond for the ultrasound to cover a full circumference of the pipe, and, if the pig is travelling at 2.0 M/sec, it will move forward by 2.0 mm in this time. For some common, useful modes of ultrasonic shear wave it will take between two and three circumferences of this pipe for the ultrasound to decay to the point where it will not mask useful data, and, during this time, the pig will have moved forward by about 5 mm.

### SUMMARY OF THE INVENTION

It would be desirable to be able to provide a pipeline inspection pig incorporating an ultrasonic transducer system capable of making quality inspection by optimising the above requirements.

According to one aspect of the present invention there is provided a pipeline inspection pig for locating and/or sizing crack-like defects in pipeline walls, the pig comprising at least one transmit transducer for transmitting ultrasound energy circumferentially around the pipeline wall, and at least one associated receive transducer located adjacent the transmit transducer, the arrangement being such that, for a given defect in the pipeline wall, ultrasound energy travelling circumferentially within the pipeline wall is incident on the defect, part of said energy being reflected by the defect circumferentially back to the receive transducer in the form of a first data stream, and the remainder of said energy passing through the defect to be attenuated thereby and thence travelling circumferentially of the wall to the receive transducer in the form of a second data stream, interpretation of the first and second data streams enabling the location and/or sizing of the defect to be determined.

Each stream of energy incorporates distinct and different information about the defect, the combination of the two enabling an accurate picture to be obtained as regards size (both depth and superficial extent), location in the pipeline wall structure, and discrimination between crack-like defects and other features which create ultrasound disturbance but which are benign to the structural integrity.

The pig may include more than one pair of transmit/receive transducers depending upon the size of pipeline under inspection. For example a 500 mm diameter pipeline may utilise an inspection pig comprising two pairs of transmit/receive transducers conveniently located substantially diametrically opposite one another, while a 900 mm diameter pipeline may comprise three pairs of transmit/receive transducers, the pairs being co-planar with one another and substantially equi-spaced about the circumference of the pig.

In each case, it is preferred that the circumferential spacing between the transmit transducer of one pair of transducers and the receive transducer of an adjacent pair of transducers is different from the spacing between the transmit transducer of the adjacent pair of transducers and the receive transducer of the one pair of transducers. This ensures the data streams being received by each receive transducer can be clearly distinguished from each other.

Preferably the transmit transducers are fired substantially simultaneously.

A preferred pipeline pig includes a plurality of rings of transmit/receive transducers, the rings being axially spaced from one another whereby the ultrasound energy from one ring does not interfere with that from the adjacent ring, while it is further preferred that the transmit/receive transducers of one ring are angularly displaced relative to those of the adjacent ring thereby to provide improved coverage of the pipe wall.

According to a further aspect of the invention there is provided a method of locating and/or sizing crack-like defects in pipeline walls using a pipeline inspection pig as defined above, the method comprising the steps of transmitting ultrasound energy circumferentially of the pipeline wall to be incident on the defect whereby part of said energy is reflected circumferentially back by the defect and the remainder of the energy passes through the defect to continue its circumferential travel in an attenuated form, the receive transducer receiving the reflected energy in the form of a first data stream and the attenuated energy in the form of a second data stream, and interpreting the first and second data streams to determine the location and/or size of the defect.

### BRIEF DESCRIPTION OF THE DRAWINGS

FIG. 1 is an isometric view of a pipeline inspection pig according to the invention;

FIG. 2 is a section through part of a pipe showing schematically the path of ultrasound energy therein, and

FIG. 3 is a section through a pipe showing the disposition of transmit and receive transducers of a pig according to the invention.

### DESCRIPTION OF THE PREFERRED EMBODIMENT

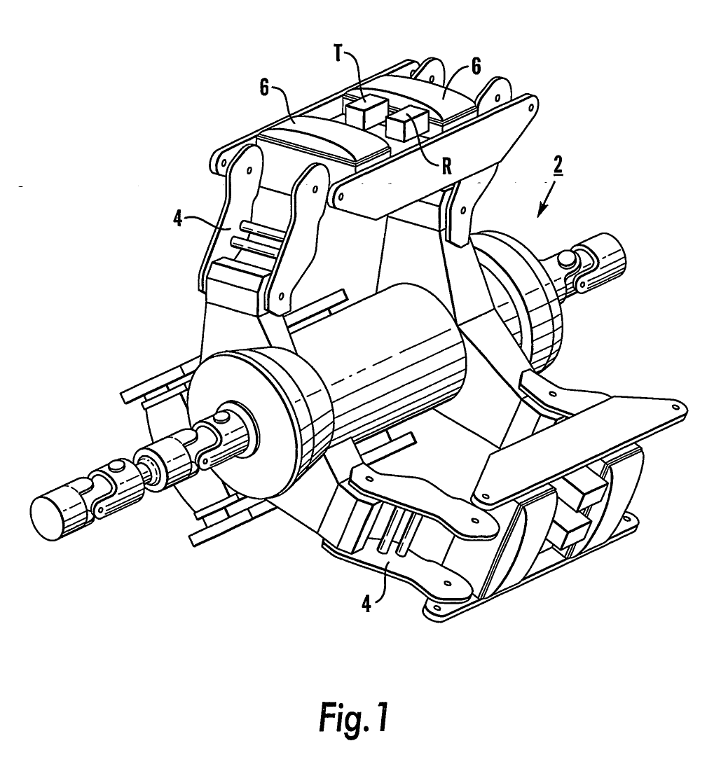

Referring to FIG. 1 of the drawings, there is shown a relatively conventional inspection pig which comprises a central body portion indicated generally at 2 from which radiate three equi-spaced suspension assemblies 4 on the outer end of each of which is mounted an EMAT transducer system, including a transmitter T and a receiver R, all the transmitters T and receivers R being co-planar.

In the illustrated arrangement, each transmitter/receiver pair is positioned between an associated pair of bias magnets 6 for noise reduction purposes as known for example from EPO775910.

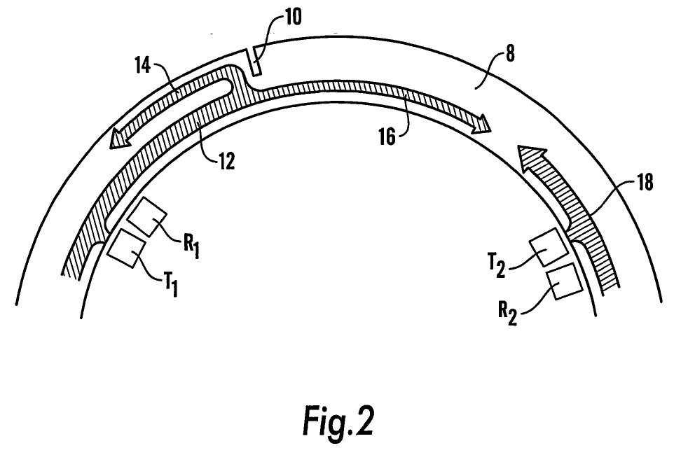

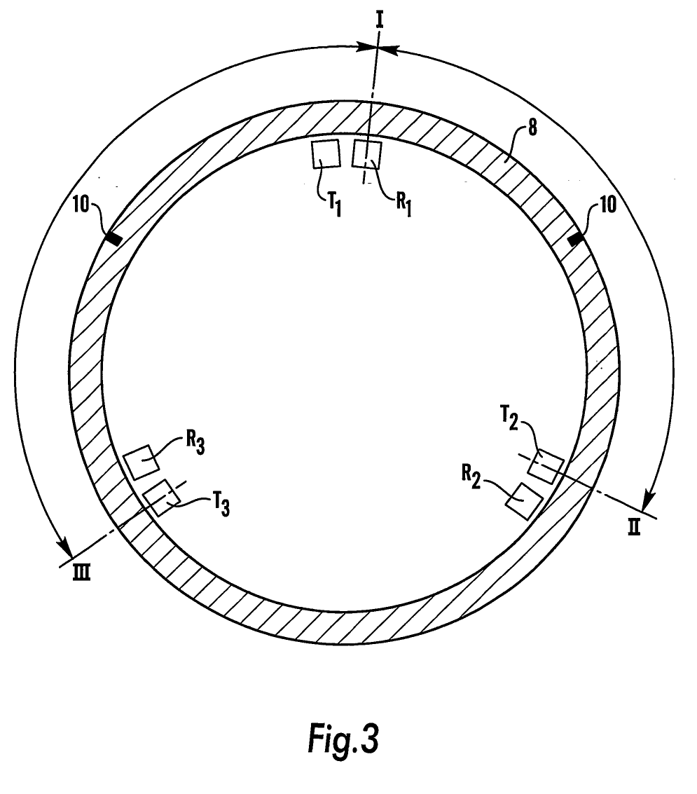

As is apparent from FIGS. 2 and 3, the transmitters T and receivers R, in use of the pig, lie closely adjacent the inside of the pipe wall 8, the transmitters T being arranged, on triggering, to inject a pulse of ultrasound energy into the wall 8 which travels as a wave circumferentially around the wall 8.

Referring to FIG. 2 there is shown a first transmitter T₁, and an adjacent associated first receiver R₁, forming a first pair, and a second transmitter T₂ and an adjacent associated second receiver R₂ forming a second pair angularly spaced from the first pair and coplanar therewith. A defect in the pipe wall 8 is shown at 10.

Considering the first pair of components T₁, R₁, the pulse of ultrasound energy created in the wall 8 on triggering of transmitter T₁ is indicated at 12 and travels circumferentially within the wall 8. The energy flowing towards the defect 10 impinges upon the defect, part of said energy, referenced 14, being reflected by the defect 10 circumferentially back towards the receiver R₂ while the attenuated remainder of the energy, referenced 16, continues to flow circumferentially within the wall 8 eventually to return to the receiver R₁. The two energy streams, on detection by the receiver R₁, are indicative of the quantity and quality of the reflected energy and the attenuated energy respectively, and the data stream so received can be interpreted by associated electronics to provide information from which the position and nature of the defect 10 can be determined.

This interpretation can be significantly improved by utilising the second transmitter/receiver pair T₂R₂as well. The transmitter T₂ is triggered at the same time as T₁ whereby a second pulse 18 of ultrasound energy is created by the transmitter T₂ to travel circumferentially around the wall 8. This pulse 18, like the pulse 12, is partly reflected and partly onwardly transmitted in attenuated form at the defect 10, whereby further circumferential energy streams are created within the wall 8 which, along with the streams originating from energy created by transmitter T₁, can be interpreted by both receivers R₁ and R₂.

More particularly, for the ultrasound pulse from T₁, immediately following the firing there will be an acoustical and electromagnetic overload at R₁ caused by the adjacent firing. This will be followed by a period of time in which the receiver R₁ will hear a reflection from the defect in the pipe wall. Also R₂ will hear the through transmission signal from T₁, and this will be attenuated by the influence of the defect in the intervening pipe wall. Finally, there will be a period where R₁ will hear reflection of the T₁ signal caused by defects in the sectors of pipe more remote from the R₁ T₁ pair. At the same time, although not shown for clarity, the pulse of energy from T₂ will interact with the defect in the same way. For each receiver, the signals described above will all appear as a single data stream giving both reflected and through transmission data, so providing an enhanced ability to detect, discriminate and size the defects. Each defect will be seen from both sides with reflected and through transmission data. Clearly the same principle will apply if the two transmitted pulses are not exactly simultaneous. Furthermore, since both transmitters in the ring fire at or about the same time, then all the ultrasonic waves will attenuate together (in parallel rather than in series) so giving the shortest time possible before the next firing. This will result in the fastest possible pulse repetition rate.

FIG. 3 shows three pairs of coplanar transmitters/receivers angularly disposed around the pipe wall (as in FIG. 1), further enhancing the ability to detect, discriminate and size the defects. It is important for the receivers to be able to discriminate between signals received from the various transmitters, and this is achieved by positioning the various transmitters and receivers such that the circumferential path between the receiver of one pair and the transmitter of a second pair is different in length than that between the receiver of the one pair and the transmitter of the third pair—ie. the path indicated by the arrow I-II is shorter than the path indicated by the arrow I-III. Thus receiver R₁ will see through transmission signals from transmitters T₂ and T₃ at different times. The signal which is attenuated tells which side of receiver R₁ contains the defect.

Thus there is provided an inspection pig incorporating a ring of co-planar transducers with at least one pair, but more preferably two or more pairs, of transducers (transmitter/receivers) in the ring. All the transmitters in the ring fire at or very near the same time to create pulses of energy travelling circumferentially of the pipeline walls and repeat this firing at a repetition rate adequate for inspection but only limited by the acoustic ring down rate. Several axially spaced rings of transducers can be combined in series with sufficient axial spacing so that the acoustical energy from one ring does not interfere with that from adjacent rings. This spacing allows simultaneous firing of several rings, so providing a maximum scanning rate. Angular displacement of one ring from another provides full coverage of the pipe wall.

The invention provides a system which has a sparsely distributed circumferential array of ultrasonic transducers where each of a small number of receiving transducers produces a data system stream that contains within the same stream both reflection and transmission data. The arrangement is economical on transducer hardware and supporting electronics, yet provides good information about defects or features, so enhancing the inspection performance. This system has a further advantage in maximising the pulse repetition rate that can be employed, and thereby maximising the number of measurements of a defect as the pig travels down the pipe.

1. A pipeline inspection pig for locating and/or sizing crack-like defects (10) in pipeline walls (8), the pig being characterised by at least one transmit transducer (T)for transmitting ultrasound energy circumferentially around the pipeline wall (8), and at least one associated receive transducer (R) located adjacent the transmit transducer (T), the arrangement being such that, for a given defect (10) in the pipeline wall (8), ultrasound energy travelling circumferentially within the pipeline wall (8) is incident on the defect (10), part of said energy being reflected by the defect (10) circumferentially back to the receive transducer (R) in the form of a first data stream, and the remainder of said energy passing through the defect (10) to be attenuated thereby and thence travelling circumferentially of the wall to the receive transducer (R) in the form of a second data stream, interpretation of the first and second data streams enabling the location and/or sizing of the defect (10) to be determined.

2. A pig as claimed in claim 1 and including a plurality of pairs of transmit/receive transducers (T₁,R₁,T₂,R₂), the pairs being co-planar with one another and substantially equi-spaced about the circumference of the pig.

3. A pig as claimed in claim 2 in which the circumferential spacing between the transmit transducer (T₁) of one pair of transducers and the receive transducer (R₂) of an adjacent pair of transducers is different from the spacing between the transmit transducer (T₂) of the adjacent pair of transducers and the receive transducer (R₁) of the one pair of transducers.

4. A pig as claimed in claim 2 or claim 3 in which the transmit transducers (T₁,T₂) are fired substantially simultaneously.

5. A pig as claimed in any one of claims 1 to 4 and including a plurality of rings of transmit/receive transducers (T,R), the rings being axially spaced from one another whereby the ultrasound energy from one ring travelling circumferentially of the pipeline wall does not interfere with that from the adjacent ring.

6. A pig as claimed in claim 5 in which the transmit/receive transducers (T,R) of one ring are angularly displaced relative to those of the adjacent ring.

7. A method of locating and/or sizing crack-like defects (10) in pipeline walls (8) using a pipeline inspection pig as claimed in any one of claims 1 to 6, the method comprising the steps of transmitting ultrasound energy circumferentially of the pipeline wall to be incident on the defect (10) whereby part of said energy is reflected circumferentially back by the defect (10) and the remainder of the energy passes through the defect (10) to continue its circumferential travel in an attenuated form, the receive transducer (R) receiving the reflected energy in the form of a first data stream and the attenuated energy in the form of a second data stream, and interpreting the first and second data streams to determine the location and/or size of the defect.
